(19) United States
(12) Patent Application Publication
(10) Pub. No.: US 2003/0083907 A1
(43) Pub. Date: May 1, 2003

(54) Insurance system, insurance server, insurance system operation method, and insurance server program storage medium

(75) Inventor: Nobuya Sato, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/057,884

(22) Filed: Jan. 29, 2002

(30) Foreign Application Priority Data
Oct. 30, 2001 (JP) 2001-332485

(51) Int. Cl. G06F 17/60

(52) U.S. Cl. 705/4

(57) ABSTRACT

There is disclosed an insurance system in which an insurance subjected to an examination can quickly be contracted. An insurance server 11 receives an application for the insurance from a client 12 via a communication network, obtains information from a customer information database 111 in which information necessary for the examination is stored, performs the examination for a contract of the insurance based on the information, and uses a prepaid balance stored in a customer account database to settle a premium, when the examination is successful.

### BACKGROUND OF THE INVENTION

i) Field of the Invention

The present invention relates to an insurance system and insurance server for receiving an application for an insurance from an applicant via a communication network and contracting the insurance, an operation system of the insurance system, and an insurance server program storage medium in which an insurance server program, incorporated in a computer, for allowing the computer to function as an insurance server is stored.

ii) Description of Related Art

A system or a server in which an insurance can be applied for so-called on-line via Internet has heretofore been known, and is convenient because one does not have to go to an insurance company for the application.

However, in these system and server, just the application can be made, and an insurance system or an insurance server in which the insurance can be contracted on-line has not existed yet.

If such insurance system or such insurance server is realized, a necessary insurance can be contracted only at a necessary time in any place. Therefore, for example, an operation in which a golfer insurance on a daily basis for a time of golf playing, a leisure insurance for a time of mountain climbing, and the like are minutely contracted if necessary is expected. That is, it is expected that a risk is finely divided and much security is obtained with a small amount of premium.

Additionally, the insurance includes an insurance in which an applicant's healthy condition is checked before the contract and an examination is performed as to whether or not to accept the contract of the insurance, and an insurance in which anyone can make a contract without requiring the examination.

Conventional examples of the non-examination insurance subjected to no examination include an insurance in which the contract is instantly established after the application, such as a daily accident insurance which is applied for in an airport at a time of traveling abroad. However, in the non-examination insurance, a uniform amount of premium is set for those who have relatively high to low risks without considering individual applicants' conditions, and there is a problem that the premium is inevitably and generally high.

On the other hand, in the insurance subjected to the examination, since the premium is set in consideration of the individual applicants' conditions, the premium is set in accordance with an applicant's risk. However, when a procedure of the insurance is simply performed on-line on an assumption of the examination, much time is required for the procedure for the examination, and insurance contract becomes valid with delay. There is also a problem that the insurance cannot quickly be contracted when necessary.

### SUMMARY OF THE INVENTION

The present invention has been developed in consideration of the aforementioned circumstances, and an object thereof is to provide an insurance system and insurance server in which an insurance subjected to the aforementioned examination can quickly be contracted, an operation method of the insurance system, and an insurance server program storage medium in which an insurance server program for operating a computer as the insurance server is stored.

To achieve the object, according to the present invention, there is provided an insurance system comprising:

a client operated by an applicant who applies for an insurance;

an applicant information storage in which applicant information relating to the applicant is stored prior to the application for the insurance;

an application receiving section which receives the application for the insurance from the applicant via the client and a communication network;

an examination section which examines acceptability of the application for the insurance received by the application receiving section based on the applicant information stored in the applicant information storage; and

a contract section which contracts the applied insurance according to a result of the examination by the examination section indicating permission.

According to the insurance system of the present invention, since the examination is performed based on the applicant information stored beforehand in the applicant information storage at a time of the application for the insurance, a time for obtaining the applicant information can be saved, and the insurance can quickly be contracted.

In the insurance system of the present invention, when the contract section contracts the insurance, a premium may automatically be paid from a bank account. The insurance contract comes into force on a condition of payment of the premium in many cases. When the automatic payment from the back account is utilized to pay for the insurance, generation of effect of the insurance is considered to be delayed because of a time required for the automatic payment.

To solve the problem, the insurance system of the present invention preferably comprises:

a charge storage which stores a charge paid prior to the application for the insurance by the applicant; and

an accounting section which uses the charge stored in the charge storage to settle a premium of the insurance at a time of the contract of the insurance by the contract section.

According to the preferable constitution of the insurance system, since the premium is paid beforehand in a so-called prepaid system, the time required for the automatic payment is saved. Immediately after the application, the insurance comes into force.

Furthermore, the insurance system of the present invention preferably includes a first authentication section which confirms agreement of a content of the insurance contracted by the contract section with a content of the insurance with the application therefor received by the application receiving section, and thereby authenticates validity of the insurance contracted by the contract section.

According to the insurance system including the first authentication section, it is guaranteed that the insurance contract is concluded with the content applied for by the applicant.

The insurance system of the present invention further comprises:

a plurality of contract sections; and

a second authentication section which totals an amount of the insurance money in the insurance to be contracted this time, and an amount of the insurance money in the insurance already contracted by the plurality of contract sections with respect to the applicant having applied for the insurance at the time of the contract of the insurance by one arbitrary contract section, confirms the total amount within a defined upper limit, and authenticates the validity of the insurance to be contracted this time.

According to the insurance system including the second authentication section, an illegal multiplex insurance contract can be avoided.

To achieve the object, according to the present invention, there is provided an insurance server comprising:

an applicant information storage in which applicant information relating to an applicant to apply for an insurance is stored prior to the application for the insurance;

an application receiving section which receives the application for the insurance from the applicant via a client operated by the applicant and a communication network;

an examination section which examines acceptability of the application for the insurance received by the application receiving section based on the applicant information stored in the applicant information storage; and

a contract section which contracts the applied insurance according to a result of the examination by the examination section indicating permission.

The insurance server of the present invention preferably comprises:

a charge storage which stores a charge paid prior to the application for the insurance by the applicant; and

an accounting section which uses the charge stored in the charge storage to settle a premium of the insurance at a time of the contract of the insurance by the contract section.

To achieve the object, according to the present invention, there is provided an insurance system operation method comprising:

an applicant information storing step of storing applicant information relating to an applicant to apply for an insurance prior to application of the insurance;

an application receiving step of receiving the application for the insurance from the applicant via a client operated by the applicant and a communication network;

an examining step of examining acceptability of the application for the insurance received by the application receiving step based on the applicant information stored by the applicant information storing step; and

a contracting step of contracting the applied insurance, when a result of the examination by the examining step indicates permission.

Moreover, to achieve the object, according to the present invention, there is provided an insurance server program storage medium in which an insurance server program incorporated in a computer is stored, the program allowing the computer to operate as an insurance server comprising:

an applicant information storage to store applicant information relating to an applicant to apply for an insurance prior to the application for the insurance;

an application receiving section to receive the application for the insurance from the applicant via a client operated by the applicant and a communication network;

an examination section to examine acceptability of the application for the insurance received by the application receiving section based on the applicant information stored in the applicant information storage; and

a contract section to contract the applied insurance according to a result of the examination by the examination section indicating permission.

### BRIEF DESCRIPTION OF THE DRAWINGS

FIG. 1 is a diagram showing one embodiment of an insurance system of the present invention, in which one embodiment of an insurance server of the present invention is incorporated.

FIG. 2 is a diagram showing an operation and detailed constitution of the insurance system.

FIG. 3 is a diagram showing items of information stored in a customer information database.

FIG. 4 is a diagram showing the items of the information stored in a primary insurance application information database.

FIG. 5 is a diagram showing a first insurance application telegram.

FIG. 6 is a diagram showing a second insurance application telegram.

FIG. 7 is a diagram showing the items of the information stored in an insurance policy management database of an insurance company.

FIG. 8 is a diagram showing an insurance authentication application telegram.

FIG. 9 is a diagram showing an insurance authentication application response telegram.

FIG. 10 is a diagram showing information of the insurance policy management database in which a result of authentication is reflected by the insurance authentication application response telegram.

FIG. 11 is a diagram showing the items of the information stored in the insurance policy management database of an insurance policy authentication organization.

### DETAILED DESCRIPTION OF THE PREFERRED EMBODIMENTS

Embodiments of the present invention will be described hereinafter with reference to the drawings.

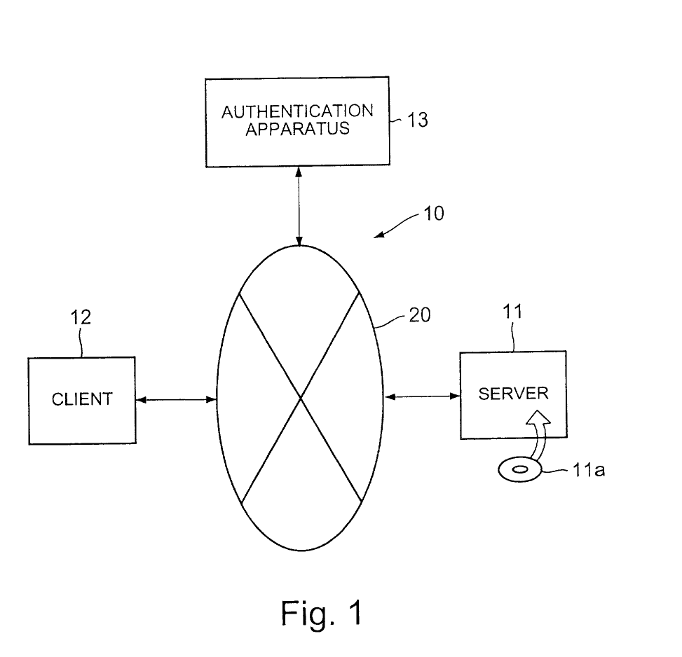

FIG. 1 is a diagram showing one embodiment of an insurance system of the present invention, in which one embodiment of an insurance server of the present invention is incorporated. In the insurance system, one embodiment of an insurance operation method of the present invention is carried out.

An insurance system 10 is constituted of a server 11, client 12, and authentication apparatus 13 connected to one another via a communication network 20 represented by Internet. The server 11 is one embodiment of the insurance server of the present invention, and includes one example of an applicant information storage mentioned in the present invention, one example of an application receiving section, one example of an examination section, and one example of a contract section as described later. The server 11 of the present invention is operated by an insurance company in the present embodiment. Moreover, the server 11 is realized by installing an insurance server program stored in a CD-ROM 11a as one example of an insurance server program storage medium of the present invention in a computer. The client 12 is one example of a client mentioned in the present invention, and is operated by a user of the insurance system 10 who corresponds to an applicant of the present invention. Moreover, the authentication apparatus 13 serves both as one example of a first authentication section and one example of a second authentication section mentioned in the present invention, and is operated by an insurance policy authentication organization independent of the insurance company in the present embodiment.

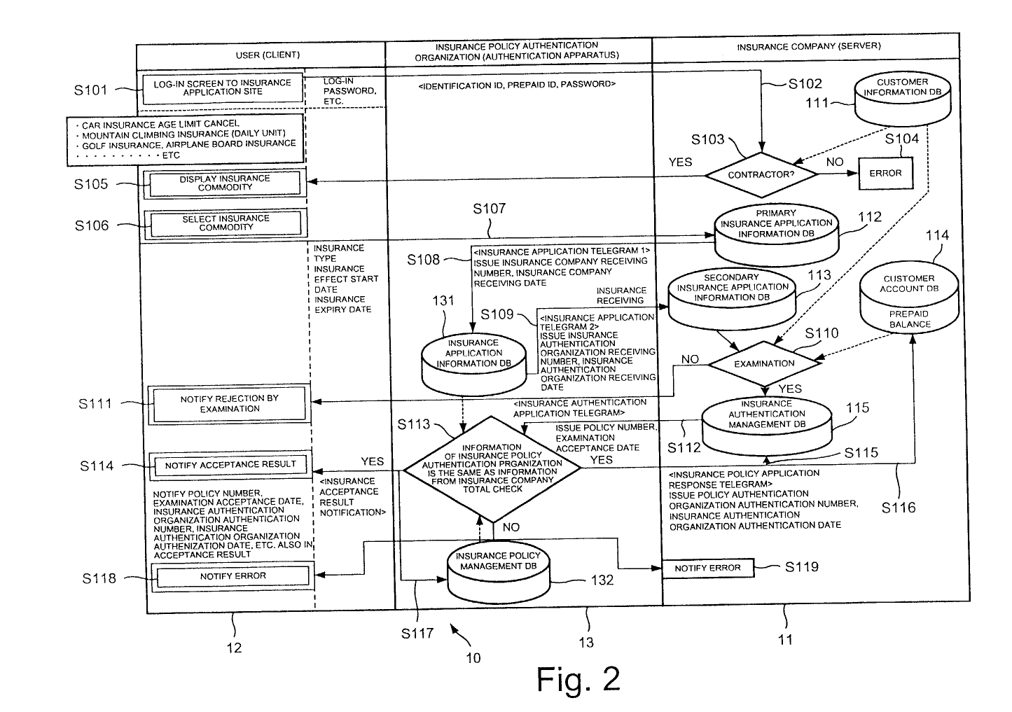

FIG. 2 is a diagram showing an operation and detailed constitution of the insurance system 10 shown in FIG. 1.

FIG. 2 also shows the insurance system 10 constituted of the server 11, client 12, and authentication apparatus 13 shown in FIG. 1, and shows operations of the server 11, client 12, and authentication apparatus 13 by solid-line arrows. These solid-line arrows indicate one embodiment of an insurance system operation system of the present invention. Function blocks shown as constituting parts of the server 11 in FIG. 2 show one example of the insurance server program mentioned in the present invention.

The user who desires to use the insurance system 10 to apply for the insurance exchanges the contract for utilizing the system with the insurance company, prepays a premium, and provides information necessary for examination at a time of insurance contract. The premium prepaid by the user is deposited in an account possessed and managed by the insurance company, and a balance of the account is stored in a customer account database 114 disposed in the server 11. The customer account database 114 is one example of a charge storage mentioned in the present invention. Moreover, the information presented from the user as the information necessary for the examination of the time of the insurance contract is stored in a customer information database 111 disposed in the server 11. The customer information database 111 is one example of an applicant information storage mentioned in the present invention.

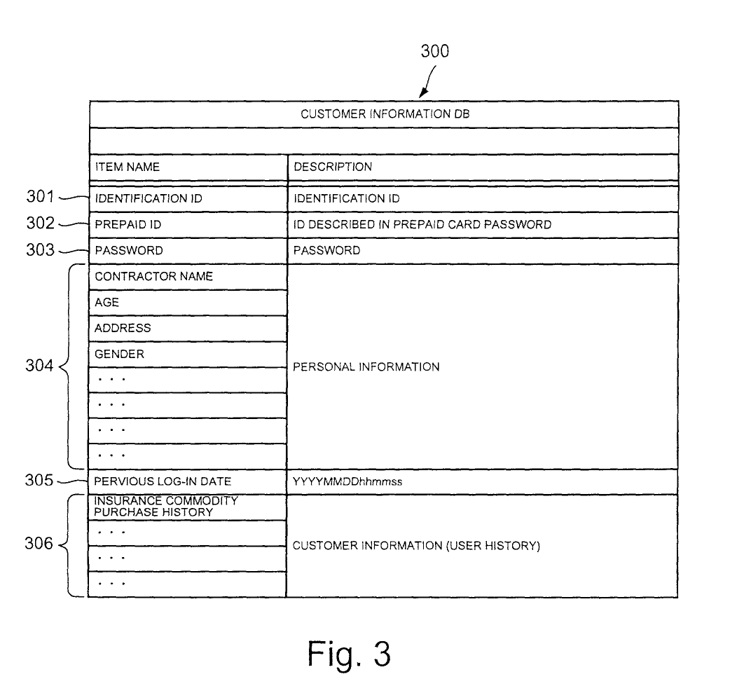

FIG. 3 is a diagram showing items of the information stored in the customer information database 111.

Information 300 constituted of the respective items shown in FIG. 3 is stored for each user of the insurance system 10 in the customer information database 111. The items constituting the information 300 stored in the customer information database 111 include: an identification ID 301 for identifying that the user is a contractor; a prepaid ID 302 which is described in a prepaid card issued for prepayment of the premium, and specifies a prepayment account; and a password 303 for confirming validity of the user. Moreover, the items constituting the information 300 also include: personal information 304 including a name, age, address, gender, and the like of the contractor (i.e., the user); a date 305 of a previous log-in to the insurance system 10; and further information 306 as the customer of the insurance company such as a purchase history of an insurance commodity.

Turning back to FIG. 2, the operation will be described.

When the client 12 displays an access screen to an insurance application site managed by the insurance company via a browser in response to the operation by the user (step S101), the operation of the insurance system 10 is started. The user inputs the aforementioned identification ID, prepaid ID, and password for the log-in to the insurance system 10 via the access screen, and the inputted ID, and the like are transmitted to the server 11 (step S102). The server 11 compares the transmitted identification ID, prepaid ID, and password with the ID stored in the customer information database 111, and confirms that the user is the contractor having exchanged the contract for system utilization with the insurance company (step S103). Here, when the contractor cannot be identified, a predetermined error processing is performed (step S104).

The server 11 identifies the contractor, and then presents the insurance commodity for which the contractor can conclude the insurance contract together with the premium in accordance with the contractor's personal information to the client 12 (step S105).

The user operating the client 12 selects the insurance commodity to apply for from the presented insurance commodities, and inputs the information necessary for the application for the insurance (step S106). The inputted information includes a type and effective period (start date and end date) of the insurance.

Additionally, when the server 11 presents the insurance commodity to the client 12, the personal information 304 stored in the customer information database 111 is written in an input form for applying for the insurance, and presented. The user can rewrite the personal information as occasion demands to easily input the information necessary for applying for the insurance.

The inputted information is sent to the server 11, and stored in a primary insurance application information database 112 disposed in the server 11 (step S107). Items of the information stored in the primary insurance application information database 112 are the same as those of the information stored in a secondary insurance application information database 113 described later, and in an insurance application information database 131 disposed in the authentication apparatus 13.

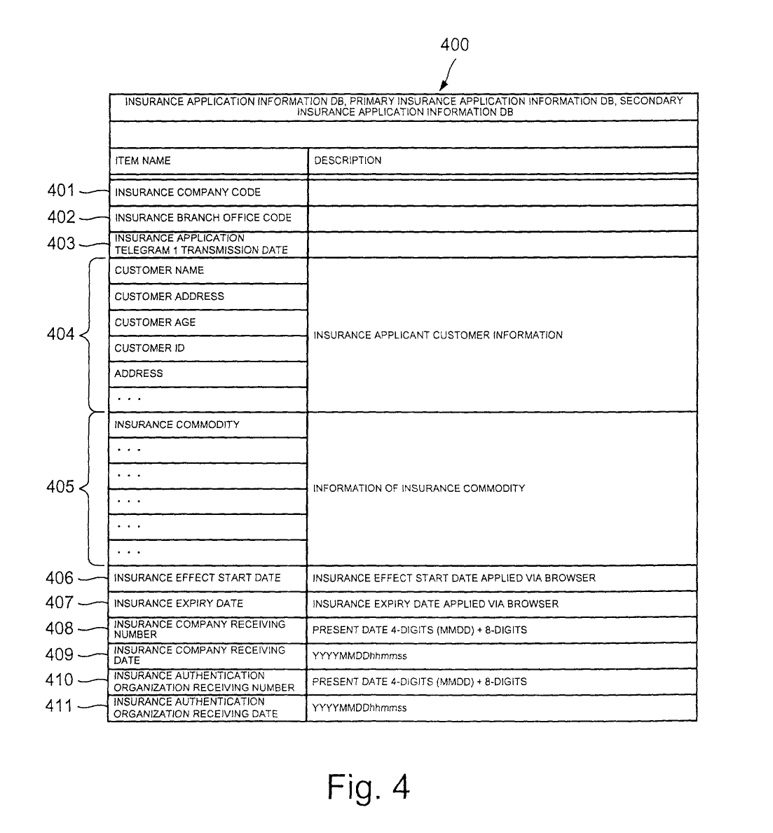

FIG. 4 is a diagram showing the items of the information stored in the primary insurance application information database 112.

Information 400 constituted of the respective items shown in FIG. 4 is stored for each insurance application to the insurance company in the primary insurance application information database 112, and the like.

The items constituting the information 400 stored in the primary insurance application information database 112 include: an insurance company code 401 and insurance branch office code 402 which specify the insurance company and a branch office of the insurance company, respectively, and a date 403 at which a first insurance application telegram described later is transmitted. Contents of these items are given by the server 11.

Moreover, the items constituting the information 400 include: insurance applicant customer information 404 constituted of a name, address, age, ID, address, and the like of the customer (user) having applied for the insurance; information 405 indicating a type of the insurance commodity subjected to the insurance application; and insurance effect start date 406 and insurance expiry date 407 indicating an effective period applied to the insurance commodity. These items are inputted by the user via the browser on the client.

Furthermore, the items constituting the information 400 stored in the primary insurance application information database 112 include: an insurance company receiving number uniformly granted to the received application for the insurance by the insurance company; an insurance company receiving date 409 indicating a date at which the application is received; an insurance authentication organization receiving number 410 uniformly granted to the application by an insurance policy authentication organization; and an insurance authentication organization receiving date 411 indicating a date at which the application is received by the insurance policy authentication organization. The insurance company receiving number 408 and insurance authentication organization receiving number 410 are each constituted of a four-digits numeric value indicating the receiving data, and eight-digits consecutive number to be reset on each receiving date.

Additionally, in the primary insurance application information database 112 shown in FIG. 2, among the respective items shown in FIG. 4, the date 403 when the first insurance application telegram is transmitted, insurance authentication organization receiving number 410, and insurance authentication organization receiving date 411 are blank.

When the information is stored in the primary insurance application information database 112 in step S107 of FIG. 2, the insurance company receiving number 408 and insurance company receiving date 409 are issued in the primary insurance application information database 112. That is, the primary insurance application information database 112 is one example of an application receiving section mentioned in the present invention. Moreover, the primary insurance application information database 112 transmits the first insurance application telegram described later to the insurance application information database 131 disposed in the authentication apparatus 13 (step S108).

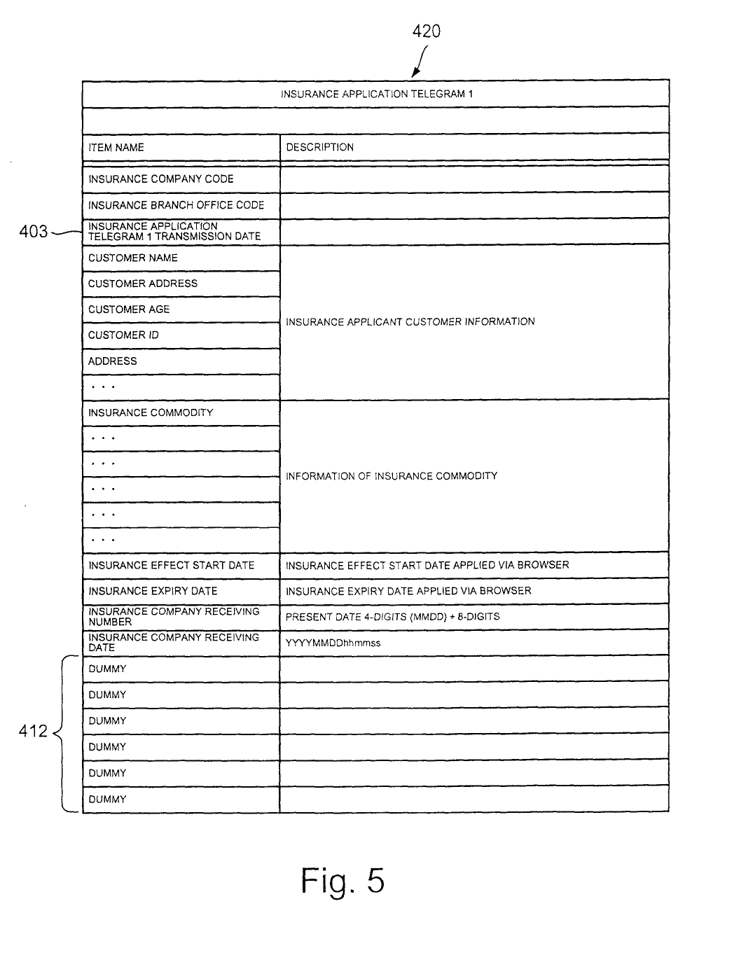

FIG. 5 is a diagram showing the first insurance application telegram.

A first insurance application telegram 420 is a telegram for transmitting the information stored in the first insurance application information database 112 to the insurance application information database 131. The first insurance application telegram 420 includes the same items as the respective items shown in FIG. 4, excluding the insurance authentication organization receiving date 410 and insurance authentication organization receiving date 411.

In the first insurance application telegram 420, the date 403 when the primary insurance application information database 112 transmits the first insurance application telegram 420 is written. Moreover, in the first insurance application telegram 420, predetermined dummy data 412 is written instead of the insurance authentication organization receiving number 410 and insurance authentication organization receiving date 411.

When the first insurance application telegram 420 is transmitted to the insurance application information database 131 in step S108 of FIG. 2, the insurance application information database 131 stores the information transmitted by the first insurance application telegram 420 as the information 400 constituted of the respective items shown in FIG. 4, and issues the insurance authentication organization receiving number 410 and insurance authentication organization receiving date 411. Subsequently, a second insurance application telegram including the issued insurance authentication organization receiving number 410 and insurance authentication organization receiving date 411 is transmitted to the secondary insurance application information database 113 of the server 11 from the insurance application information database 131 as described later (step S109).

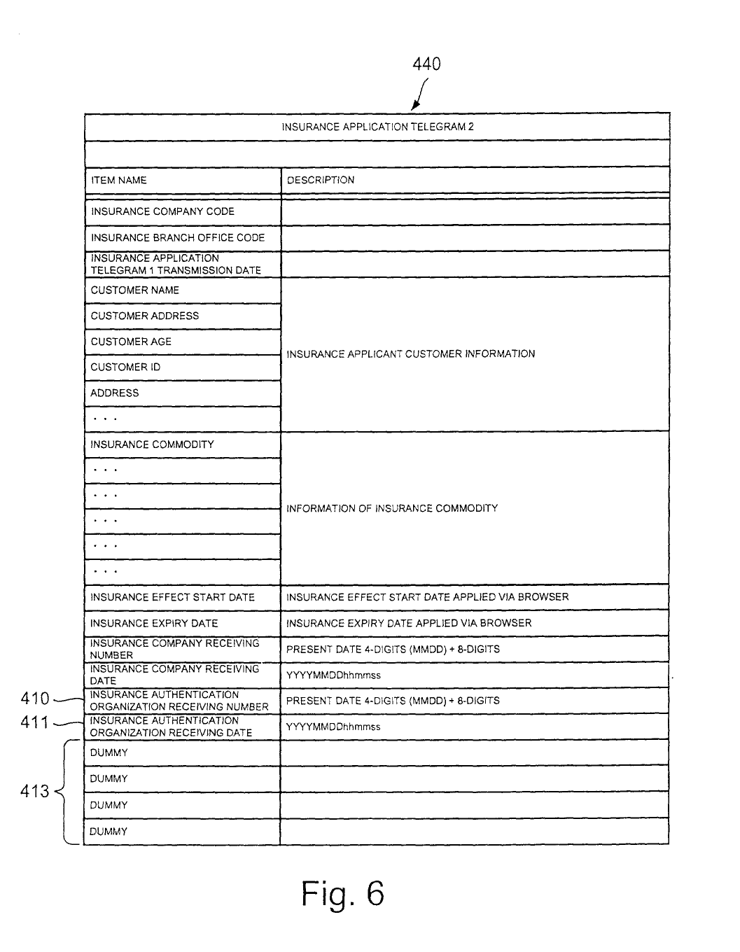

FIG. 6 is a diagram showing the second insurance application telegram.

A second insurance application telegram 440 is a telegram for transmitting the information stored in the insurance application information database 131 to the secondary insurance application information database 113. The second insurance application telegram 440 includes the same items as the respective items shown in FIG. 4. Moreover, the second insurance application telegram 440 includes the written insurance authentication organization receiving date 410 and insurance authentication organization receiving date 411 issued by the insurance application information database 131, and further includes predetermined dummy data 413.

When the second insurance application telegram 440 is transmitted to the secondary insurance application information database 113 in step S109 of FIG. 2, the information transmitted by the second insurance application telegram 440 is stored as the information 400 constituted of the respective items shown in FIG. 4 in the secondary insurance application information database 113.

When the information is successively stored in the primary insurance application information database 112, insurance application information database 131, and secondary insurance application information database 113, the insurance company and insurance policy authentication organization share the application content of the insurance.

When the application for the insurance is made in the step S107, and the content of the application is shared by the insurance company and insurance policy authentication organization, the server 11 of the insurance company examines acceptability of the insurance contract with the user with respect to the applied insurance (step S110). The step S110 corresponds to a function of an examination section mentioned in the present invention. In the present embodiment, the examination is performed based on the information stored in the customer information database 111 in the step S110. Additionally, an examination as to whether or not a sufficient balance is stored in the customer account database 114, an examination based on an accident history of a traffic accident, an examination based on a so-called black list in which premium nonpayment history, and the like are described, and the like are performed. Moreover, since the examination is performed based on the information stored in the customer information database 111, the examination is performed without delay immediately after the application for the insurance.

As a result of the examination in the step S110, when the insurance contract is rejected (step S110: NO), the rejection of the insurance contract is notified to the address included in the insurance applicant customer information 404 shown in FIG. 4 (step S111). FIG. 2 shows an example in which the address of an electronic mail is designated, and the client 12 refers to the electronic mail sent to the address.

On the other hand, as a result of the examination in the step S110, when the insurance contract is permitted (step S110: YES), an insurance policy management database 115 disposed in the server 11 issues the insurance policy, and the insurance contract is established. That is, the insurance policy management database 115 has a function as one example of a contract section mentioned in the present invention. The insurance policy management database 115 issues a number of the insurance policy and an acceptance date of the examination when issuing the insurance policy. Moreover, the insurance policy management database 115 stores the information for managing the issued insurance policy.

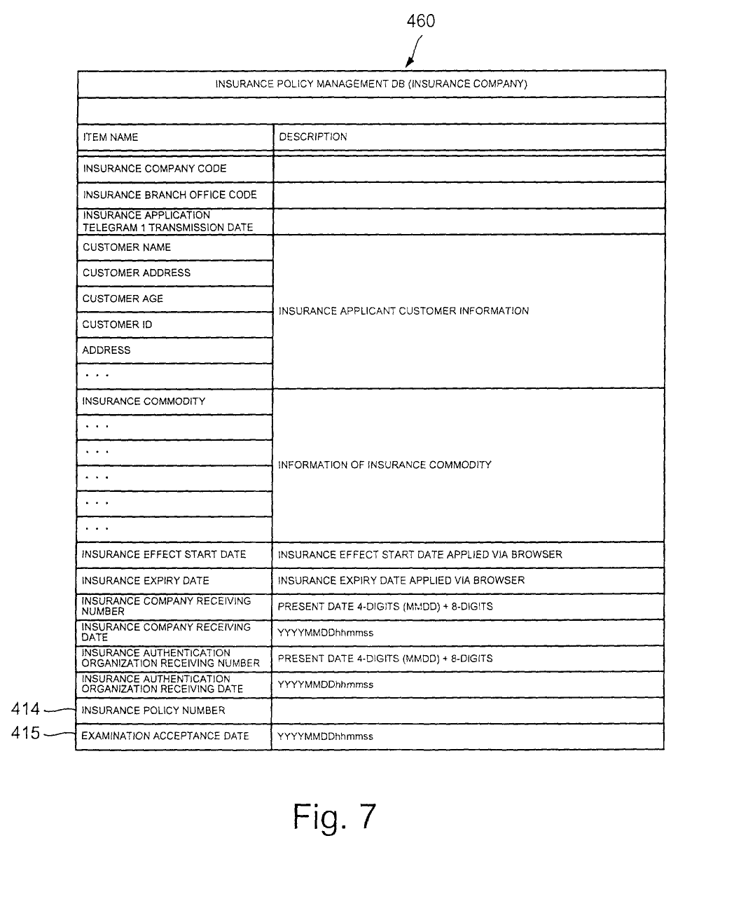

FIG. 7 is a diagram showing the items of the information stored in the insurance policy management database 115.

Information 460 stored in the insurance policy management database 115 includes the same items as those shown in FIG. 4, and also includes an insurance policy number 414 and examination acceptance date 415 issued as described above. Furthermore, the information 460 shown in FIG. 7 is transmitted to the authentication apparatus 13 of the insurance policy authentication organization from the insurance policy management database 115 via an insurance authentication application telegram described later (step S112).

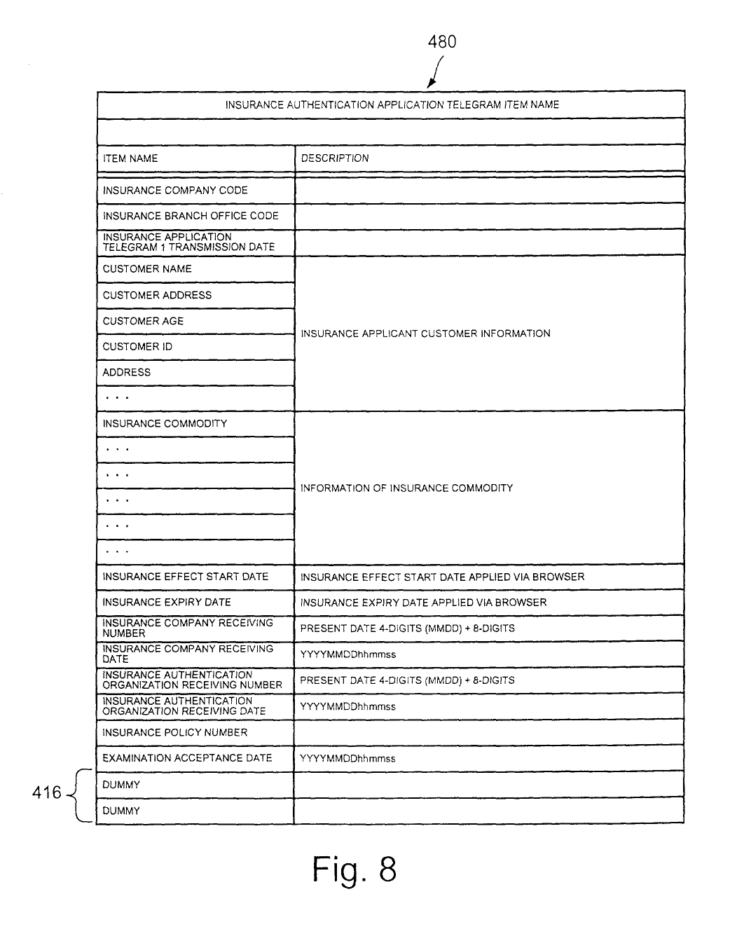

FIG. 8 is a diagram showing the insurance authentication application telegram.

An insurance authentication application telegram 480 is a telegram for transmitting the information 460 stored in the insurance policy management database 115 to the authentication apparatus 13, includes the same items as those shown in FIG. 7, and further includes predetermined dummy data 416.

When the information is transmitted to the authentication apparatus 13 via the insurance authentication application telegram 480, the authentication apparatus 13 performs the following two checks in order to authenticate validity of the contracted insurance (step S113).

In a first check, it is judged whether a content of the insurance contract indicated by the information transmitted by the insurance authentication application telegram 480 agrees with a content of the application indicated by the information stored in the insurance application information database 131 of the insurance policy authentication organization. It is confirmed by the first check that the insurance of the content applied for by the user is correctly contracted.

In a second check, information stored in an insurance policy management database 132 is used, in which the information equal to the information stored in the insurance policy management database 115 is stored with respect to a plurality of insurance companies. It is then judged whether a total amount of the insurance money of the insurance contract in the plurality of insurance companies with respect to the same user is within a legally admitted upper-limit amount. It is confirmed by the second check that the user applies for the insurance within a legally valid range.

When both these checks are successful, an authentication number and date are first issued with respect to the insurance having the validity authenticated, and an acceptance result including the insurance policy number, examination acceptance date, authentication number, and authentication date is notified to the user's address included in the insurance authentication application telegram 480 (step S114). Moreover, the result of the authentication is reflected in the information of the insurance policy management database 115 of the insurance company by an insurance authentication application response telegram described later (step S115).

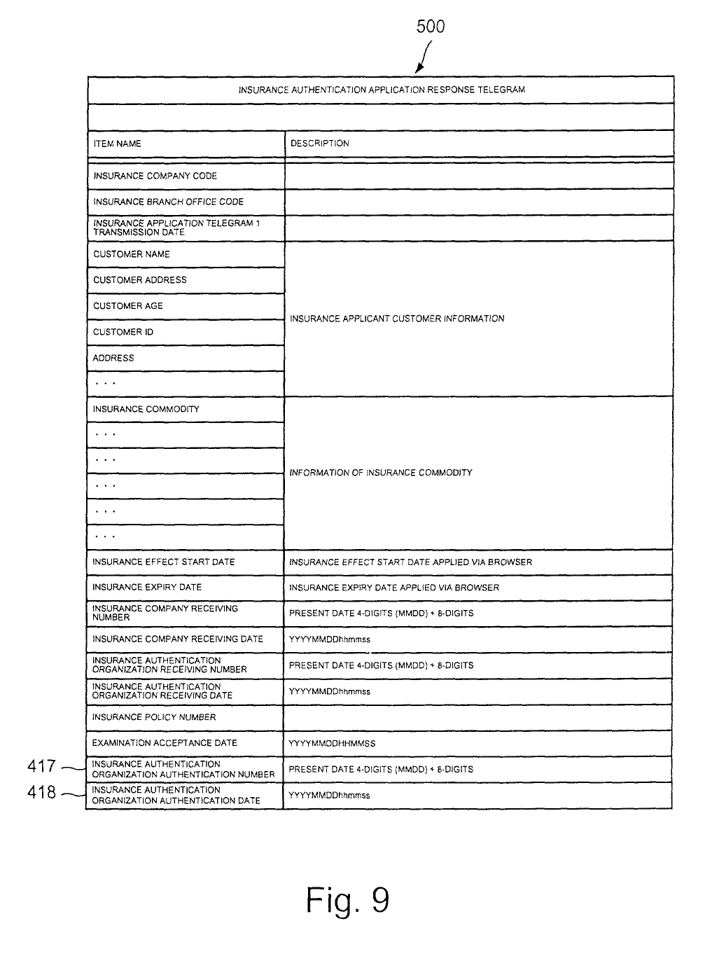

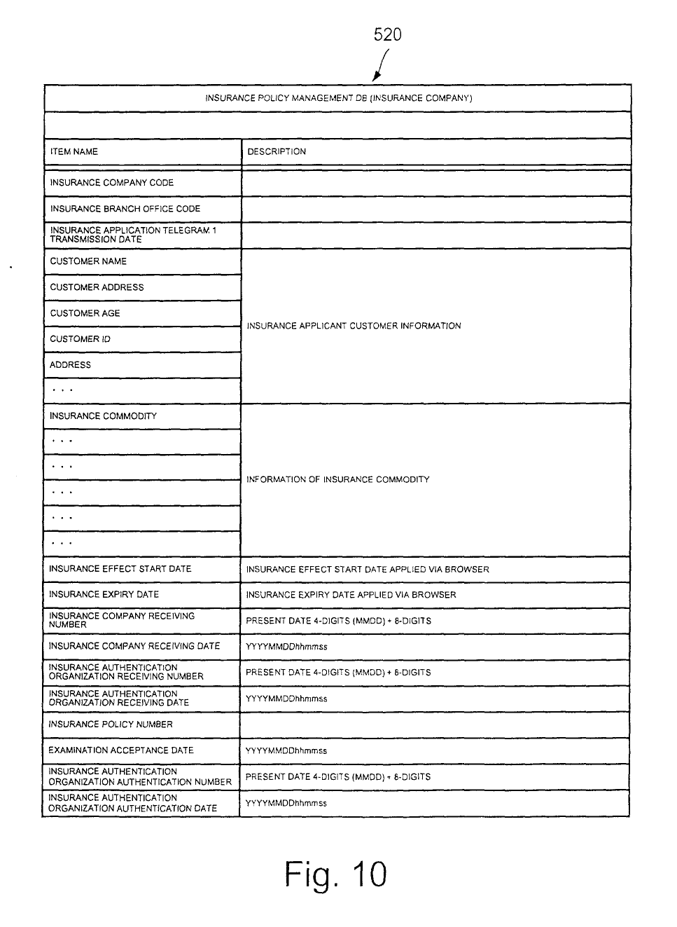

FIG. 9 is a diagram showing the insurance authentication application response telegram, and FIG. 10 is a diagram showing information of the insurance policy management database 115 in which the result of authentication is reflected by the insurance authentication application response telegram.

An insurance authentication application response telegram 500 shown in FIG. 9 includes the same items as those included in the insurance authentication application telegram 480 shown in FIG. 8, and also includes an authentication number 417 and authentication date 418 issued by the insurance authentication organization instead of the dummy data 416 included in the insurance authentication application telegram 480.

In the insurance policy management database 115 in which the result of authentication is reflected by the insurance authentication application response telegram 500, as shown in FIG. 10, information 520 constituted of the same items as those included in the insurance authentication application response telegram 500 is stored.

In step S115 shown in FIG. 2, the result of authentication is reflected in the insurance policy management database 115, the balance stored in the customer account database 114 is used, and the premium is settled (step S116). Therefore, the customer account database 114 also has a function of an accounting section mentioned in the present invention.

Furthermore, with respect to the insurance in which the validity of the contract is authenticated, the information indicated by the insurance authentication application response telegram 500 is stored in the insurance policy management database 132 of the insurance policy authentication organization (step S117).

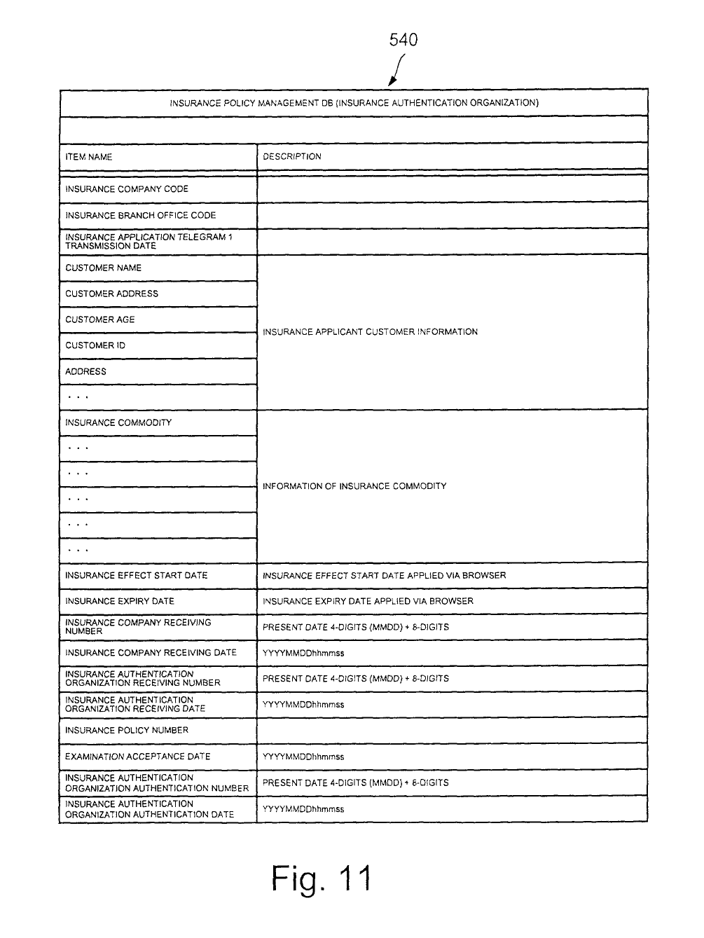

FIG. 11 is a diagram showing the items of the information stored in the insurance policy management database 132.

Information 540 stored in the insurance policy management database 132 includes the same items as those constituting the information 500 stored in the insurance policy management database 115 of the insurance company and shown in FIG. 9. Additionally, only the information relating to the insurance contracted by the insurance company is stored in the insurance policy management database 115 of the insurance company, but information relating to the insurance contracted by the plurality of insurance companies is stored in the insurance policy management database 132 of the insurance policy authentication organization.

Additionally, when one or both of the two checks in the step S113 of FIG. 2 is unsuccessful, an error is notified to the user's address (electronic mail address referred to by the client 12 herein) and the server 11 of the insurance company (steps S118, S119).

By the aforementioned operation of the insurance system 10, the user can apply for the insurance from an arbitrary place at an arbitrary time, and can quickly come into the insurance. Therefore, the operation for making the contract of various types of insurance in detail as occasion demands can be realized, and it is possible to finely divide the risk and obtain large security with little premium.

Moreover, the operation for the application for the insurance has been described above, but the insurance system 10 can also be applied to application for a change of an insurance content by substantially the same operation as the aforementioned operation.

Furthermore, when the client 12 operated by the user is a so-called mobile terminal, usefulness of the insurance system 10 is particularly remarkable. However, even when the client 12 is a stand-alone personal computer, or even in a place of a terminal apparatus disposed in specific facilities, an effect of the present invention is sufficiently fulfilled.

As described above, according to the present invention, the policy of the insurance subjected to the examination can quickly be held. Thereby, it is possible to finely divide the risk and to obtain large security with little premium.

What is claimed is:

1. An insurance system comprising:
a client operated by an applicant who applies for an insurance;
an applicant information storage in which applicant information relating to said applicant is stored prior to the application for the insurance;
an application receiving section which receives the application for the insurance from said applicant via said client and a communication network;
an examination section which examines acceptability of the application for the insurance received by said application receiving section based on the applicant information stored in said applicant information storage; and
a contract section which contracts the applied insurance according to a result of the examination by said examination section indicating permission.

2. The insurance system according to claim 1, further comprising:
a charge storage which stores a charge paid prior to the application for the insurance by said applicant; and
an accounting section which uses the charge stored in said charge storage to settle a premium of the insurance at a time of the contract of the insurance by said contract section.

3. The insurance system according to claim 1, further comprising:
a first authentication section which confirms agreement of a content of the insurance contracted by said contract section with a content of the insurance with the application therefor received by said application receiving section, and thereby authenticates validity of the insurance contracted by said contract section.

4. The insurance system according to claim 1, further comprising:
a plurality of said contract sections; and
a second authentication section which totals an amount of the insurance money in the insurance to be contracted this time, and an amount of the insurance money in the insurance already contracted in said plurality of contract sections with respect to the applicant having applied for the insurance at the time of the contract of the insurance by one arbitrary contract section, confirms the total amount within a defined upper limit, and authenticates the validity of the insurance to be contracted this time.

5. An insurance server comprising:
an applicant information storage in which applicant information relating to an applicant to apply for an insurance is stored prior to an application for the insurance;
an application receiving section which receives the application for the insurance from said applicant via a client operated by the applicant and a communication network;
an examination section which examines acceptability of the application for the insurance received by said application receiving section based on the applicant information stored in said applicant information storage; and
a contract section which contracts the applied insurance according to a result of the examination by said examination section indicating permission.

6. The insurance server according to claim 5, further comprising:
a charge storage which stores a charge paid prior to the application for the insurance by said applicant; and
an accounting section which uses the charge stored in said charge storage to settle a premium of the insurance at a time of the contract of the insurance by said contract section.

7. An insurance system operation method comprising:
an applicant information storing step of storing applicant information relating to an applicant to apply for an insurance prior to an application for the insurance;
an application receiving step of receiving the application for the insurance from said applicant via a client operated by the applicant and a communication network;
an examining step of examining acceptability of the application for the insurance received by said application receiving step based on the applicant information stored by said applicant information storing step; and
a contracting step of contracting the applied insurance, when a result of the examination by said examining step indicates permission.

8. An insurance server program storage medium in which an insurance server program incorporated in a computer is stored, said program allowing the computer to operate as an insurance server comprising:
an applicant information storage to store applicant information relating to an applicant to apply for an insurance prior to an application for the insurance;
an application receiving section to receive the application for the insurance from said applicant via a client operated by the applicant and a communication network;
an examination section to examine acceptability of the application for the insurance received by said application receiving section based on the applicant information stored in said applicant information storage; and
a contract section to contract the applied insurance according to a result of the examination by said examination section indicating permission.
